(19) United States
(12) Patent Application Publication
(10) Pub. No.: US 2005/0283403 A1
(43) Pub. Date: Dec. 22, 2005

(54) Point of sale systems with interchangeable interface modules and open status of multiple cash drawers

(75) Inventors: Adriel Ramirez, Round Lake, IL (US); Paul E. Specht, Glenview, IL (US)

Correspondence Address: ERNEST A. RODRIQUEZ;1258 MT. BAKER HIGHWAY, BELLINGHAM, WA, 98226, US

(73) Assignee: Block And Company

(21) Appl. No.: 11/158,964

(22) Filed: Jun. 22, 2005

Related U.S. Application Data
(60) Provisional application No. 60/581,844, filed on Jun. 22, 2004.

(51) Int. Cl. G06F 17/60

(52) U.S. Cl. 705/16

(57) ABSTRACT

A cash drawer includes a housing, a drawer slidably mounted in the housing, and an interface module for communicating with a point of sale (POS) system in a selected communications protocol, such as printer driven, standard serial, multi-serial or USB. The module may be conveniently replaced to adapt the cash drawer to a different communication protocol. A sensor senses the open position of the drawer. In multiple cash drawer embodiments, a unique identity associated with each drawer is communicated to the interface module such that any open drawer in the plurality of cash drawers can be uniquely identified. Related methods are also disclosed.

### CROSS-REFERENCE TO RELATED PATENT APPLICATION

This patent application is a non-provisional patent application of U.S. provisional patent application Ser. No. 60/581,844, filed on Jun. 22, 2004, the right of priority of which is hereby claimed for this patent application.

### FIELD OF THE INVENTION

The present invention relates generally to electronic cash drawers for point of sale (POS) systems. More particularly, the invention relates to controlling and monitoring of cash drawers in a POS system and to interchangeable interface modules to conveniently adapt the cash drawer to different types of communication protocol.

### BACKGROUND OF THE INVENTION

Point of sale systems typically employ a computer and a number of devices, such as a display, a keyboard, a barcode reader, a credit card reader, one or more cash drawers and a printer. Other devices may also be included, such as an electronic scale. The computer has a plurality of ports for sending and receiving information to and from the other devices, including at least one serial port, which is frequently called a COM port. For example, many computers have two COM ports that are identified as COM1 and COM2 ports. These COM ports bi-directionally communicate in the well-known RS232 data format. Some of these devices may be connected to other ports of the computer, such as a USB port, which may require the installation of a separate interface circuit board or card in the computer for each device that is connected to each separate port. In some POS systems, the printer directly controls the opening of the cash drawer.

Some POS systems utilize more than one cash drawer at each site, which enables multiple store clerks to each have their own cash drawer at a single POS site. However, such prior art POS systems are capable of monitoring only one cash drawer at a time.

There has been a long-felt need for apparatus that more effectively controls and monitors multiple cash drawers in a POS system, especially at each POS site.

A general object of the present invention is to provide apparatus and methods for controlling or monitoring multiple cash drawers, such as at a single POS site.

Another general object of the present invention is to provide apparatus and methods for easily changing the communication protocol used by a cash drawer.

A further object of the present invention is to provide interchangeable interface modules that adapt a cash drawer to interface with different types of communication protocol in a POS system.

Yet another object of the present invention is to provide apparatus and methods for uniquely identifying an open drawer in a POS system with multiple cash drawers.

A still further object of the present invention is to provide apparatus and methods for conveniently and efficiently interfacing a cash drawer to a plurality of different types of interfaces, such as a printer driven interface, a standard serial interface, a multi-serial interface or a USB interface.

### SUMMARY OF THE INVENTION

The present invention is directed to a cash drawer for a point of sale system, including a housing, a drawer slidably mounted in the housing such that the drawer is movable between an open position and a closed position, a first interface module mounted on the housing, the first interface module having an electrical connector for communicating information about the status of the cash drawer with the point of sale system in accordance with a first type of communication protocol, and the first interface module is replaceable with a second interface module having a second type of communication protocol. The first interface module may be selected from a printer driven interface module, a standard serial interface module, a multi-serial interface module or a USB interface module. The second interface module may also be selected from a printer driven interface module, a standard serial interface module, a multi-serial interface module or a USB interface module. A sensor senses the open position or the closed position of the drawer and is in electrical communication with the first interface module to communicate the position of the drawer to the connector. Electronic circuitry is in communication with the connector and communicates a unique identity associated with the cash drawer to the connector.

The present invention is also directed to plurality of cash drawers for a point of sale system in which any open drawer in the plurality of cash drawers can be uniquely identified, including a housing, a drawer slidably mounted in the housing such that the drawer is movable between an open position and a closed position, a first interface module mounted on the housing, the first interface module having an electrical connector for communicating information about the status of the cash drawer with the point of sale system in accordance with a first type of communication protocol, a sensor to sense the open position or the closed position of the drawer, the sensor in electrical communication with the first interface module to communicate the position of the drawer to the connector, and electronic circuitry in communication with the connector, the electronic circuitry communicating a unique identity associated with each of the plurality of cash drawers to the connector, such that any open drawer in the plurality of cash drawers can be uniquely identified. The first interface module in each of the plurality of cash drawers may be replaced with a second interface module having a second type of communication protocol. For example, the first and second interface modules may be selected from a printer driven interface module, a standard serial interface module, a multi-serial interface module or a USB interface module.

The present invention further contemplates methods of providing an interchangeable communication protocol for a cash drawer for a point of sale system, including the steps of providing a housing for the cash drawer, mounting a drawer in the housing such that the drawer is movable between an open position and a closed position, mounting an interface module on the housing; and providing an electrical connector on the interface module for communicating information about the status of the cash drawer with the point of sale system in accordance with a selected type of communication protocol. Additional steps of the method may include replacing the interface module with another interface module having another type of communication protocol, selecting the interface module from a printer driven interface module, a standard serial interface module, a multi-serial interface module or a USB interface module, selecting the another interface module from a printer driven interface module, a standard serial interface module, a multi-serial interface module or a USB interface module, sensing the open position or the closed position of the drawer, communicating the position of the drawer to the connector of the interface module, and communicating a unique identity associated with any open cash drawer to the connector of the interface module.

Another aspect of the present invention is to provide methods of sensing and identifying an open drawer in a plurality of cash drawers for a point of sale system, including the steps of providing a housing for each of the plurality of cash drawers, mounting a drawer in each housing such that the drawer is movable between an open position and a closed position, mounting an interface module on each housing, providing an electrical connector on each interface module for communicating information about the status of each cash drawer with the point of sale system in accordance with a type of communication protocol, sensing the open position or the closed position of each drawer, communicating the position of each drawer to the respective connector and communicating a unique identity associated with each of the plurality of cash drawers to the respective connectors, such that any open drawer in the plurality of cash drawers can be uniquely identified. Additional steps may include replacing the interface module with another interface module having another type of communication protocol, selecting the interface module from a printer driven interface module, a standard serial interface module, a multi-serial interface module or a USB interface module, and selecting the another interface module from a printer driven interface module, a standard interface module, a multi-serial interface module or a USB interface module.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the figures in which like reference numerals identify like elements, and in which:

FIG. 1 is a front perspective view of a point of sale platform including a single cash drawer constructed in accordance with the present invention;

FIG. 2 is a front perspective view of a point of sale platform including two cash drawers constructed in accordance with the present invention;

FIG. 3 is a bottom internal perspective view of a cash drawer with an interchangeable interface module for connection of the cash drawer to a drawer controller in accordance with the present invention;

FIG. 4 is a front perspective view of the printer driven interface module shown in FIG. 3;

FIG. 5 is a rear perspective view of the printer driven interface module shown in FIGS. 3 and 4;

FIG. 6 is a front perspective view of a standard serial interface module that may be used instead of, or to replace, the printer driven interface module in FIGS. 3-5;

FIG. 7 is a rear perspective view of the standard serial interface module shown in FIG. 6;

FIG. 8 is a front perspective view of a multi-serial interface module that may be used instead of, or to replace, the printer driven interface module in FIGS. 3-5 or the standard interface module in FIGS. 6 and 7;

FIG. 9 is a rear perspective view of the multi-serial interface module shown in FIG. 8;

FIG. 10 is a front perspective view of a USB interface module that may be used instead of, or to replace, the printer driven interface module in FIGS. 3-5, the standard serial interface module of FIGS. 6 and 7 or the multi-serial interface module of FIGS. 8 and 9;

FIG. 11 is a rear perspective view of the USB interface module shown in FIG. 9;

FIG. 12 perspective view of the latch mechanism that locks the cash drawer of FIG. 1 and that releases the cash drawer upon activation by one of the printer driven, standard serial, multi-serial or USB interface modules shown in FIGS. 4-11;

FIGS. 13A and 13B are schematic diagrams of the electronic circuitry used in the multi-serial interface module shown in FIGS. 8 and 9;

FIG. 14 is a table setting forth the operation of the electronic circuitry shown in FIG. 13 for various settings of a first switch in the electronic circuitry of FIG. 13;

FIG. 15 is a table setting forth the operation of the electronic circuitry shown in FIG. 13 for various settings of a second switch in the electronic circuitry of FIG. 13;

FIG. 16 is a table setting forth the operation of the electronic circuitry shown in FIG. 13 for various settings of a third switch when in the smart mode;

FIG. 17 is a table setting forth the operation of the electronic circuitry shown in FIG. 13 for various settings of a third switch when in the dumb mode;

FIG. 18 is a table setting forth the baud rate selection of the electronic circuitry shown in FIG. 13 with certain settings of the third switch;

FIG. 19 is a table setting forth the pulse count selection of the electronic circuitry shown in FIG. 13 with certain settings of the third switch; and

FIG. 20 is an electrical wiring diagram for connecting two cash drawers to one computer port.

### DESCRIPTION OF THE PREFERRED EMBODIMENT

A point of sale (POS) platform, generally designated 10, constructed in accordance with the present invention is shown in FIG. 1. POS platforms 10 are sometimes referred to as POS terminals. By way of example, POS platform 10 may include a keyboard 11 for entry of alphanumeric information by an attendant, a printer 12 for printing a receipt, typically at conclusion of the transaction or sale, a display 13 for viewing transaction information, another smaller screen 14 that is typically viewed by a customer, a bay or garage 15 for containing additional equipment, a computer 16 which may be of any type including a personal computer (PC), and a drive or CD ROM 17. Additional equipment not shown in FIG. 1 may also be included in the POS platform 10, such as a barcode reading device, an RFI tag reading device or a modem for communication between POS platform 10 and a server or central computer system that communicates with multiple POS platforms 10. Cash drawer 20 typically has a drawer 24 slidably mounted therein and that is opened at a selected point in a transaction for cash transactions, for placing coupons or receipts therein, or the like. POS platform 10 thus has a single cash drawer 20.

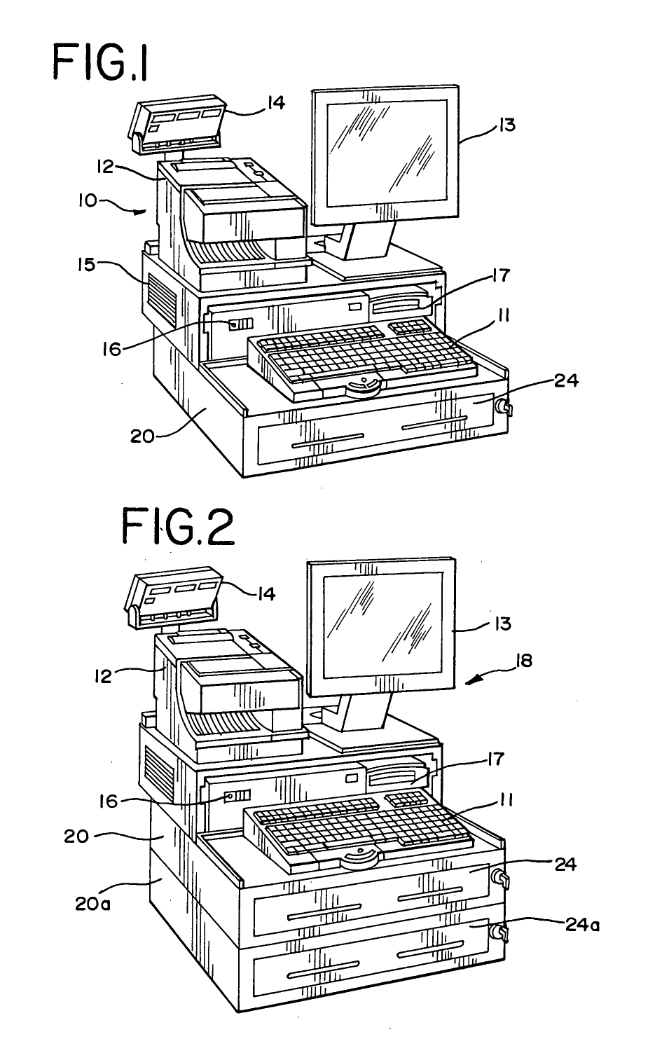

Illustrated in FIG. 2 is another POS platform, generally designated 18, which is similar in arrangement to POS platform 10 of FIG. 1 except that POS platform 18 includes a second cash drawer 20a with a sliding drawer 24a. Frequently, where more than one attendant operates the same POS platform, it is desirable to have a separate cash drawer for each attendant. Thus, while FIG. 2 shows two cash drawers 20 and 20a for use by two attendants, it will be appreciated that POS platform 18 could also be constructed to accommodate more than two cash drawers if POS platform 18 will typically be operated by more than two attendants.

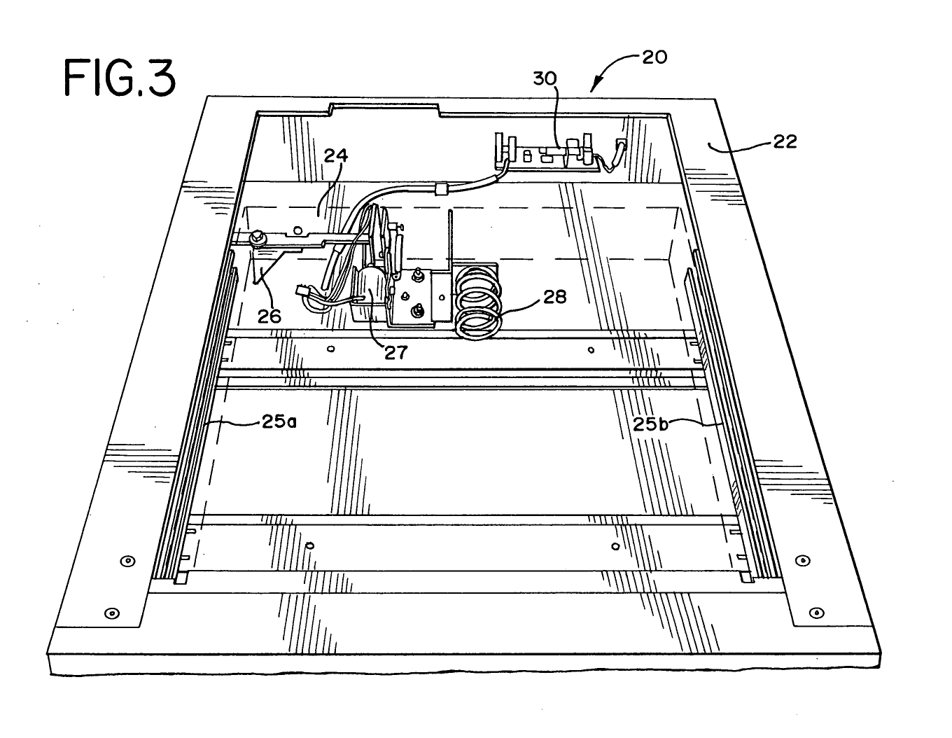

A cash drawer, generally designated 20, constructed in accordance with the present invention is shown in FIG. 3. It includes a generally rectangular housing 22 that may be formed from sheet metal by metal forming processes known in the art. The cash drawer is provided with a top panel (not shown) to enclose the housing 22. However, FIG. 3 illustrates the cash drawer 20 with the bottom panel removed so that other interior components can be seen. A drawer 24 is slidably mounted in housing 22 between a pair of opposing rails 25a and 25b. Drawer 24 is illustrated in phantom lines to enable the viewing of other interior components of cash drawer 20. As is typical, drawer 24 has a plurality of compartments for holding paper currency and coins. Drawer 24 is normally latched in a closed position by a latch mechanism 26 and may be released by activation of an electrical solenoid 27. To this end, a spring 28 associated with latch 26 will bias the drawer 24 toward an open position upon release of latch 26.

In accordance with one aspect of the present invention, an interface module 30 is provided to interface with differently configured point of sale systems to actuate the latch 26 and to communicate the status of the cash drawer 20, especially the open or closed condition of drawer 24. For example, interface module 30 may be interchanged or replaced with another style or type of interface module 30 that will interface with a serial port, such as the RS232 data transmission format, with a printer driven port, such as the type of port commonly used for printers, or with a USB type of port. Preferably, interface module 30 is affixed to the frame 22 of cash drawer 20 such as on a back side thereof, as shown in FIG. 3, and is removable therefrom such that one style of interface module 30 may be readily interchanged or replaced with a different style, if so desired. For example, in FIG. 3, interface module 30 may be mounted to cash drawer 20 by means of treaded fasteners 32. Other means of attaching module 30 to cash drawer 20 will be readily apparent to those skilled in the art, including various types of thermoplastic modules that may snappingly or resiliently engage to or in an aperture defined in the housing 22 of the cash drawer 20. Additionally, it may be desirable to provide interface module 30 with more than a single type of interface, such as both printer driven and serial ports, or with all three types of ports, namely printer driven, serial and UBS. However, for most applications, it will be more economical to provide interface module 30 with a single port of the desired or needed type since some ports require additional circuitry, as will be better appreciated in view of the disclosure below.

The ease of interchanging interface module 30 enables cash drawer 20 to be fitted with an interface module 30 with the desired type of port instead of purchasing a new cash drawer that is equipped with a port of the desired type. Thus, an existing cash drawer may be quickly adapted to interface with a different POS system, rather than ordering a new cash drawer with the correct interface for that POS system. Furthermore, an existing cash drawer 20 may be easily retrofitted with a port of the desired type if or when an associated POS terminal is updated or changed to a style that requires a different type of port on the cash drawer to mate therewith.

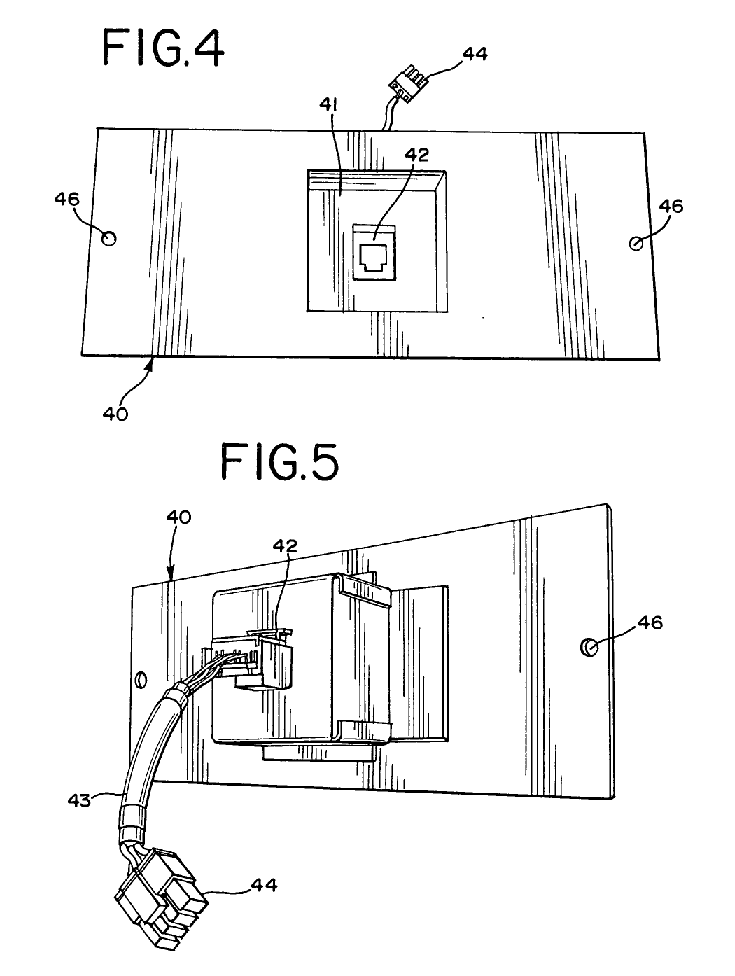

FIGS. 4 and 5 illustrate a printer-driven interface module, generally designated 40, for attachment to cash drawer 20 of FIG. 3, such as in an aperture defined in the rear of the housing 22 of cash drawer 20. Printer driven interface module 40 may also be referred to herein as a printer driven interface module. Attachment of module 40 to cash drawer 20 may be by means of threaded fasteners 29 (FIG. 3) through apertures 46, or by any other suitable means of attachment. Interface module 40 may be formed from any suitable material, such as sheet metal, plastic or the like. A female connector 42, such as of the RJ12 type, is attached to or supported by interface module 40 for receiving a corresponding male connector of the RJ12 type. In this embodiment, connector 42 is disposed within a recessed area 41 formed in module 40 for protection of connector 42 and of the mating connector that will be connected to it. Recessing of connector 42 also reduces the depth needed by cash drawer 20 when fully installed and operational within a POS system. This male connector will typically be on the end of a cable from a printer in the POS system, such that interface module 40 will receive electronic signals. For example, signals that are RS232 compatible, including an open pulse signal from the printer to drive the solenoid. The printer will thus control and activate the cash drawer 20 to release drawer 24 at the appropriate or desired time.

At the backside of module 40 as seen in FIG. 5, a cable 43 is connected to connector 42. Cable 43 has a male connector 44 at its other end, which in this embodiment consists of four terminals, to interface with a mating connector of the latch mechanism 26. Preferably, all styles of interface modules 30 utilize the same form of connector 44 to facilitate ease of interconnection with the mating connector of the latch mechanism 26.

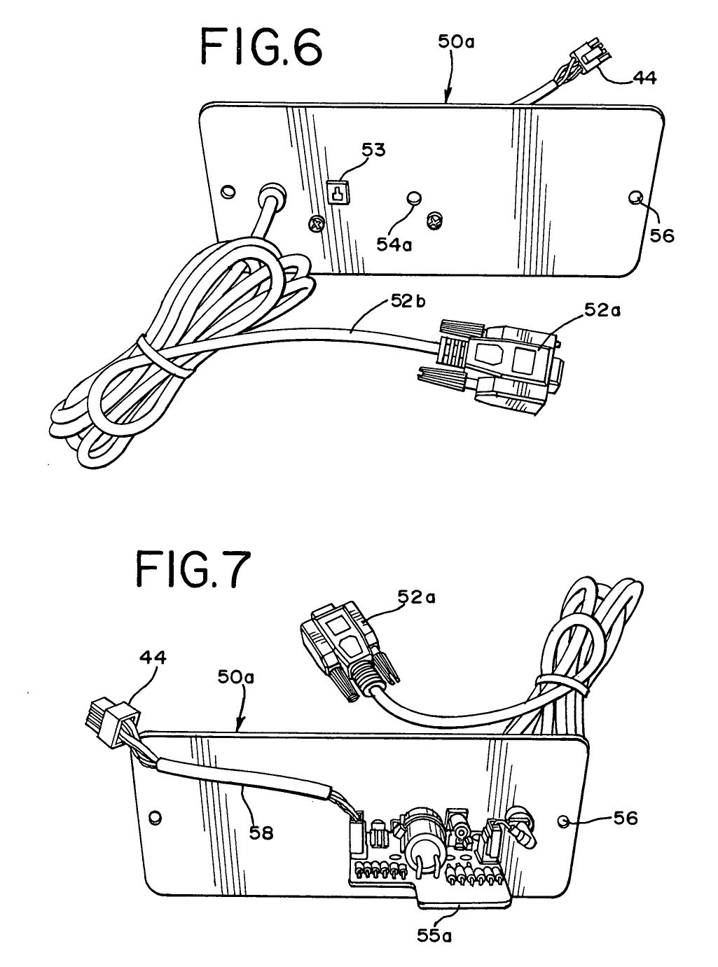

Another type of interface module, generally designated 50a, is shown in FIGS. 6 and 7. Interface module 50a is of the standard serial interface type with a multiple terminal connector 52a for connecting to a corresponding multi-pin connector. Module 50a may be attached to the rear of the housing 22 of cash drawer 20, such as by means of threaded fasteners through apertures 56, or by any other suitable means of attachment. Interface module 50a may be formed from any suitable materials including sheet metal, plastics or the like.

Connector 52a of module 50a is suited for connection to a multi-wire cable, such as to a personal computer (PC) or the like. For example, module 50a may use the RS232 protocol to communicate with a COM port of a PC, such as computer 16. Entry of any ASCII code at the PC may result in a command being sent from the PC to the electronic circuitry 55a via connector 52a to open the cash drawer 20. Electronic circuitry 55a will then generate an open pulse, which is sent via cable 58 and connector 44 to the solenoid 31. Solenoid 31 then releases arm 32 of latch mechanism 26 to release drawer 24 to its open condition (FIGS. 3 and 12). Upon opening of drawer 24, sensor 33 will send a signal to the electronic circuitry 55a, which will report the open status of drawer 24 to the PC, such as via pin 9 of connector 52a. Pin 9 may be the ring indicator pin in the RS232 protocol. The voltage level of the ring indicator signal on pin 9 may be changed by circuitry 55a such that PC 16 can differentiate between the open and closed conditions of drawer 24.

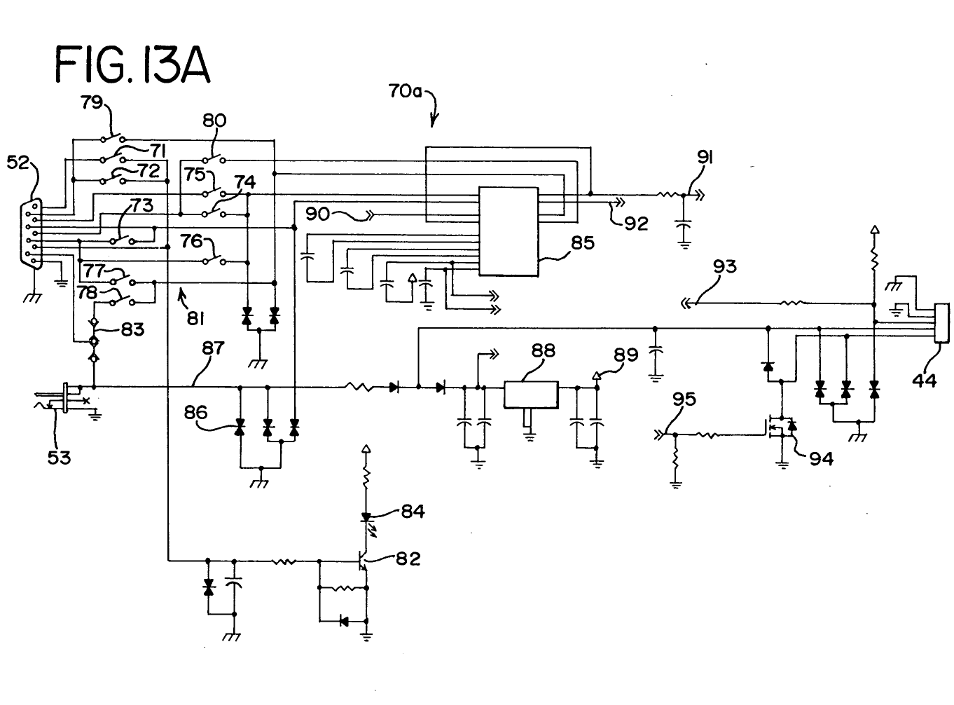

Connector 52a is connected via a cable 52b to a printed circuit board 55a, which can be seen in FIG. 7. Printed circuit board 55a contains electronic circuitry which is similar to that discussed below with reference to FIGS. 13A and 13B and which monitors the electronic signals at connector 52a to determine when to activate the latch mechanism 26 to open drawer 24. Circuit board 55a may be attached to the back side of module 50a. Also disposed on module 50a a connector 53a for supplying operating power to the electronic circuitry on circuit board 55a. For example, power to connector 53a may be supplied from the 12 VDC available from computer 16. A multi-wire cable 58 provides signals from the electronic circuitry to the male connector 44, which mates with a similar type female connector of the latch mechanism 26. A light emitting diode (LED) 54a may be used to indicate the operational status of module 50a. Interface module 50a can thus be used in place of interface module 40 when it is desired to use the cash drawer 20 with the multi-terminal connector 52a instead of the RJ12 connector 42 of interface module 40, or interface module 50a can be interchanged with interface module 40 if there is a need to change from the style of connector 42 to the style of connector 52a.

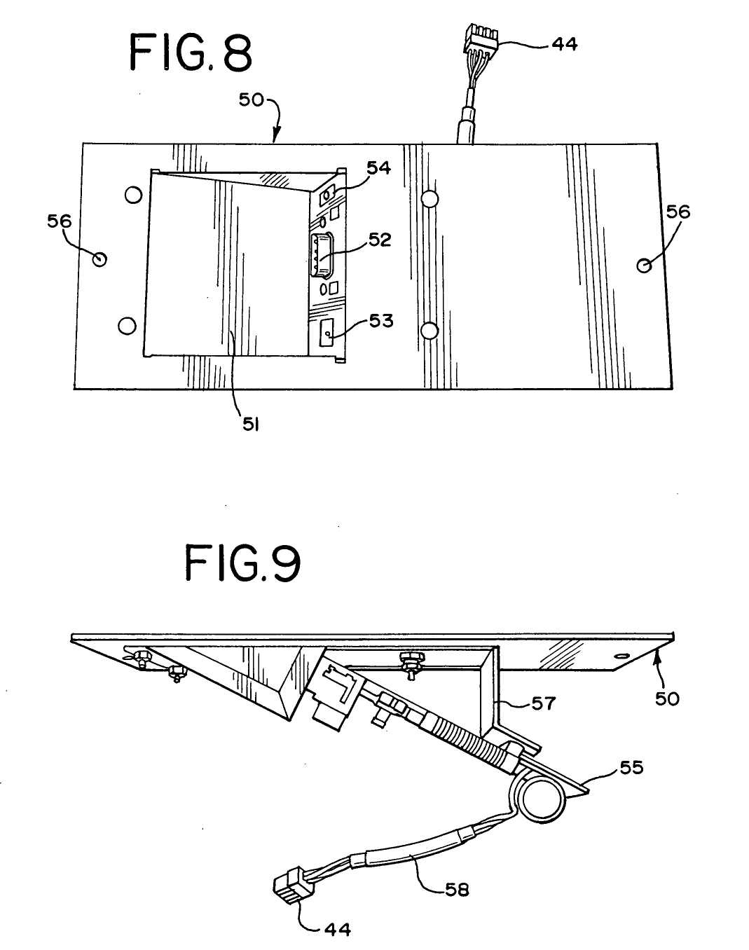

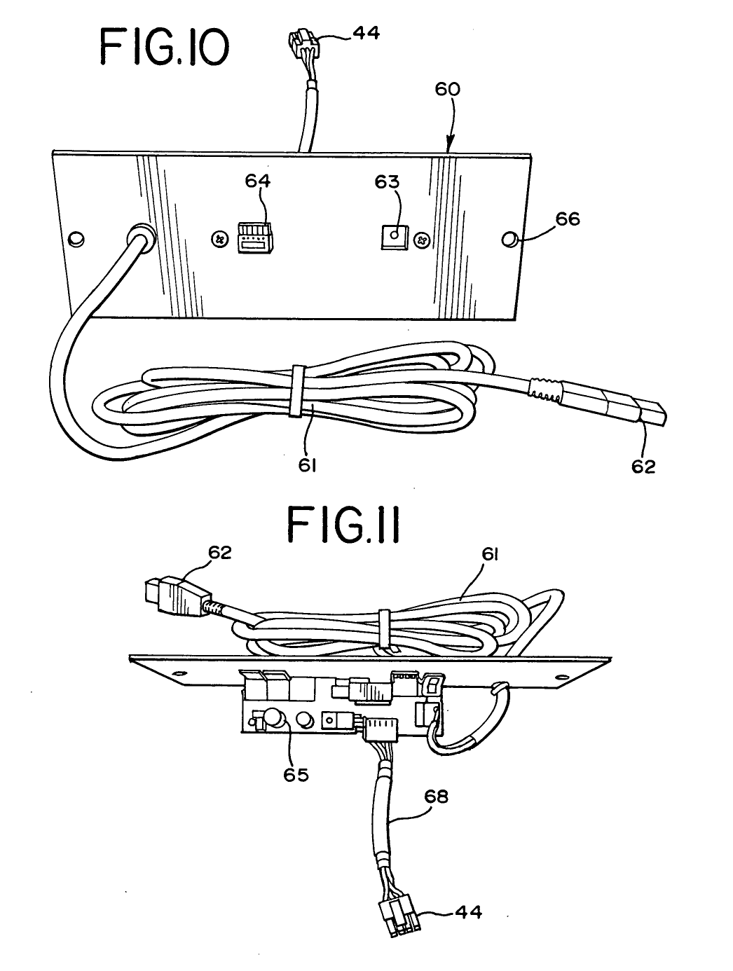

A further type of interface module, generally designated 50, is shown in FIGS. 8 and 9. Interface module 50 is of the multi-serial interface type with a multiple terminal connector 52 disposed within a wedge-shaped recess 51. Multi-serial interface module 50 is similar to the standard serial interface module 50a of FIGS. 6 and 7, but provides increased functionality. Module 50 may be attached to the rear of the housing 22 of cash drawer 20, such as by means of threaded fasteners through apertures 56, or by any other suitable means of attachment. Interface module 50 may be formed from any suitable materials including sheet metal, plastics or the like.

Connector 52 of module 50 is suited for connection to a multi-wire cable, such as from a printer. Connector 52 is disposed on a printed circuit board 55, which can be seen in FIG. 9. Printed circuit board 55 contains electronic circuitry which is discussed below with reference to FIGS. 13A and 13B and which monitors the electronic signals at connector 52 to determine when to activate the latch mechanism 26 to open drawer 24. A bracket 57 mounted to module 50 orients circuit board 55 at an oblique angle to module 50 and at the orientation to dispose connector 52 in the wedge-shaped recess 51. Also disposed in the wedge-shaped recess 51 is a connector 53 for supplying operating power to the electronic circuitry on circuit board 55. For example, power to connector 53 may be supplied from the 12 VDC available from computer 16. A multi-wire cable 53 provides signals from the electronic circuitry to the male connector 44, which mates with a similar type female connector of the latch mechanism 26. One or more LEDs 54 may be used to indicate the operational status of module 50, such as for power on, transmitting data, or the like. Interface module 50 can thus be used in place of interface module 40 when it is desired to use the cash drawer 20 with the multi-terminal connector 52 instead of the RJ12 connector 42 of interface module 40, or interface module 50 can be interchanged with interface module 40 if there is a need to change from the style of connector 42 to the style of connector 52. Similarly, interface module 50 may be used in place of interface module 50a, or interchanged therewith, if the increased functionality of module 50 is needed or desired. This increased functionality is described more fully below.

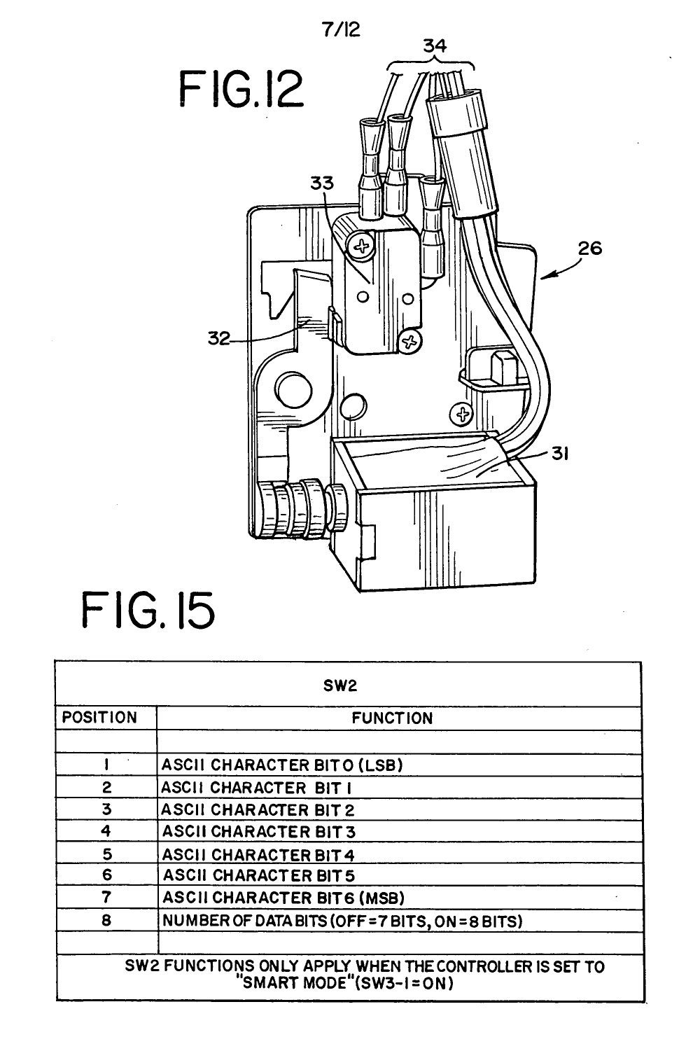

With reference to FIGS. 10 and 11, an interface module 60 is illustrated for applications in which the cash drawer 20 requires a connector 62 of the USB type for connection to a computer or the like. USB connector 62 is connected at one end of a multi-wire cable 61, with the other end of cable 61 connected to a printed circuit board 65. Circuit board 65 has electronic circuitry similar to that shown in FIGS. 13A and 13B to monitor electronic signals on cable 61 to determine when to open drawer 24 by releasing latch mechanism 26. To this end, another multi-wire cable 68 from circuit board 65 terminates in connector 44, which is compatible with a complementary connector of latch mechanism 26.

As with interface modules 40 and 50, interface module may be fabricated from any suitable materials including sheet metal, plastics or the like. It is also suited to be mounted on the back of cash drawer 20, such as by threaded fasteners through apertures 66, or any other suitable means of attachment. As seen in FIG. 10, a terminal 63 is provided for furnishing electrical power to the electronic circuitry on circuit board 65 and a multiple switch 64 is provided to select settings or operation of the electronic circuitry.

Since interface module 60 has the same type of connector 44 to mate with the latch mechanism 26 as interface modules 40, 50 and 50a, interface module 60 may be used in place of interface modules 40, 50 or 50a when it is desired for cash drawer 20 to be compatible with a USB style of connector. At any time, interface module 60 may be used to easily and economically replace interface module 40, 50 or 50a if compatibility with USB connector 62 is desired instead of with RJ12 connector 42 or with multi-terminal connector 52. Thus, it is not necessary to purchase a new cash drawer with USB compatibility, nor is it necessary to provide multiple types of connectors when only one will be used in any particular POS installation. Additionally, a USB hub may be used to connect two or more cash drawers, each equipped with USB interface module 60 and having a USB connector 62, to a single USB input port of computer 16.

While the foregoing modules 40, 50, 50a and 60 adapt the cash drawers 20 and 20a to communicate with printer driven, multi-serial, standard serial and USB communication protocols, it will be appreciated that additional or substitute communication protocols may exist or be created in the future. One such example is a parallel module. Accordingly, additional modules may be developed to accommodate such additional or substitute communication protocols so that the cash drawers may be easily adapted to communicate with such protocols. This eliminates the need to acquire new cash drawers that are equipped with the desired communication protocol.

A portion of the latch mechanism 26 is shown in greater detail in FIG. 12. A solenoid 31 is actuated by the electronic circuitry when it is desired to open drawer 24. Solenoid 31 may have more than one winding to be compatible with actuation from 24 volts, such as with interface module 40, or with actuation from 12 volts, such as with interface module 50 or 60. Actuation of solenoid 31 causes a rotating arm 32 to rotate counterclockwise from the position shown in FIG. 12 to cause drawer 24 to be released. A sensor 33 senses the position of arm 32 to determine if drawer 24 is opened or closed. A plurality of wires 34 provide signals for activation of solenoid 31 and for transmission of the open or closed condition of drawer 24 to the electronic circuitry in the case of interface modules 50 and 60 or to connector 42 in the case of interface module 40. It will be appreciated that a ground wire and one of the power wires has been duplicated in FIG. 12 for both the sensor 33 and the solenoid 31. These duplicate wires are combined such that the latch mechanism 26 is compatible with the four-terminal connector 44 shown in FIGS. 5, 7, 9 and 11.

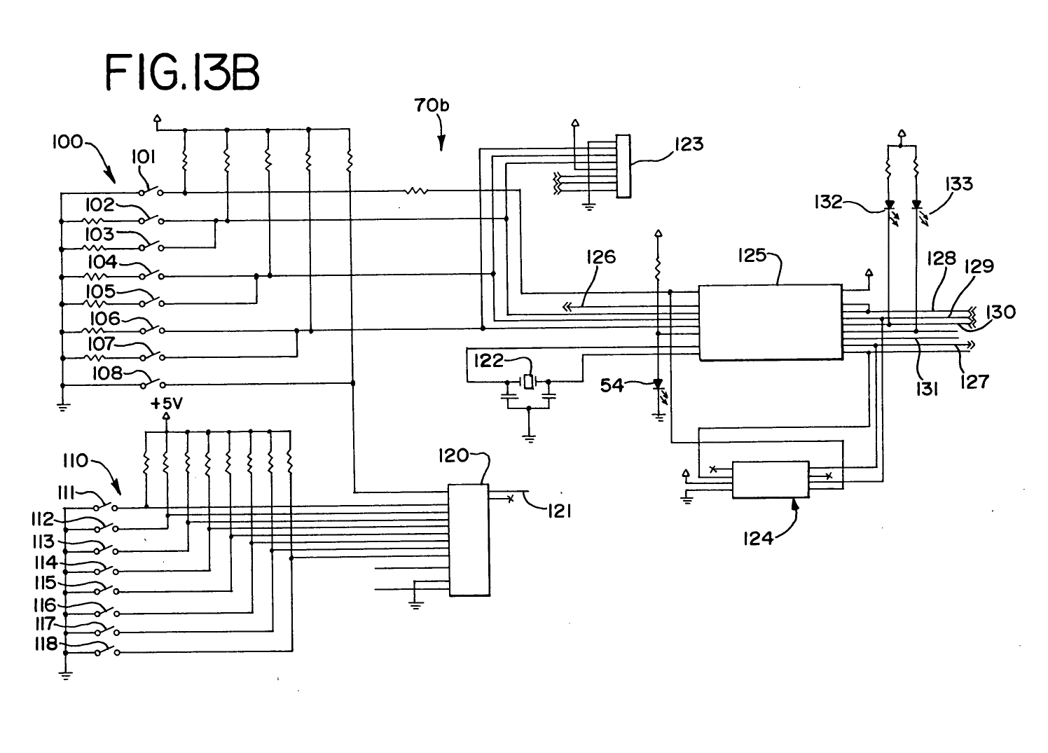

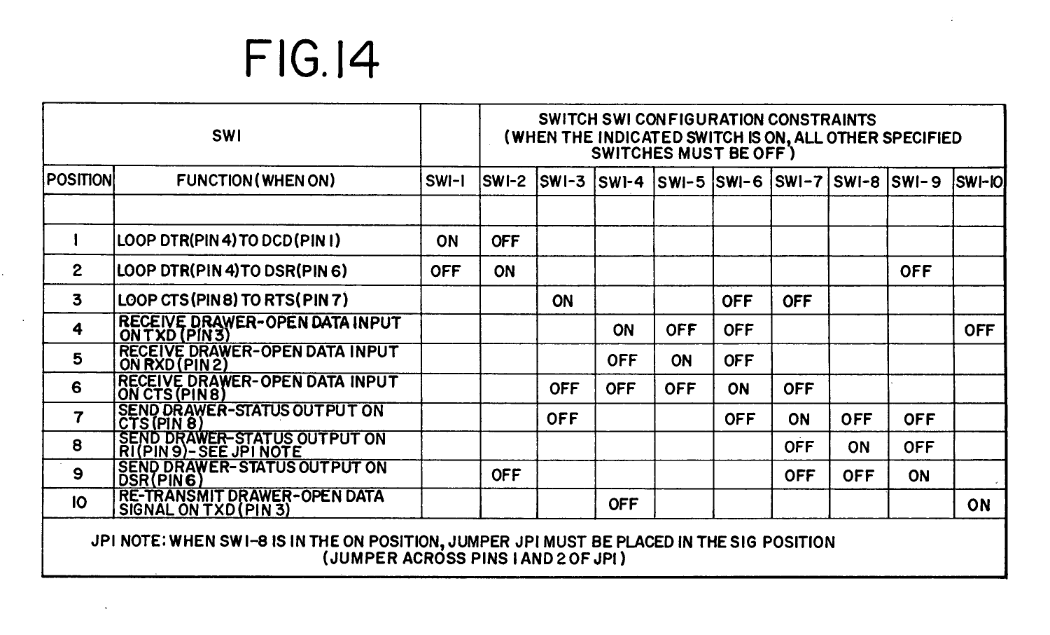

An example of the electronic circuitry for the serial interface module 60 is generally designated 70a in FIG. 13A and 70b in FIG. 13B. Collectively, the circuitry shown in FIGS. 13A and 13B may be referred to by reference numeral 70 with the understanding that the electronic circuitry 70 includes the circuitry 70a and 70b. First, with respect to circuitry 70a in FIG. 13A, a nine-pin connector 52 provides and receives electronic signals. This is the same connector 52 shown in FIGS. 8 and 9. Except for the ground terminal of connector 52, the other terminals are routed to a plurality of switches 71-80 that are collectively referred to as switch SW1 and by general reference numeral 81. Switches 71-80 correspond to the 10 switch positions 1-10 identified in the table of FIG. 14, respectively. Pin 1 of connector 52 provides a DCD signal to switch 71. When switch 71 is closed, the DCD signal is applied to the base terminal of an NPN transistor 82 to activate one or more LEDs in an LED panel 54, which is also shown in FIG. 8. For example, LED panel 54 may consist of three LEDs to indicate the open or closed position of drawer 24, the status of power to the electronic circuitry and the status of RS232 signal traffic. Likewise, when switch 72 is closed, a DSR signal from pin 6 of connector 52 is applied to the base terminal of transistor 82 for the same purpose. Otherwise, a DTR signal from pin 4 of connector 52 is applied to the base of transistor 82.

If switch 73 is closed, a CTS signal from pin 8 of connector 52 is applied to an input terminal of an RS232 driver/receiver IC 85. IC 85 is, for example, commercially available from Analog Devices, Inc. of Norwood, Mass. under part number ADM202. If switch 74 is closed, a TXD signal from pin 3 of switch 52 is applied to another input terminal of IC 85. This TXD signal is indicative of a drawer 24 open input signal. Alternatively, switch 75 may apply an RXD signal from pin 2 of connector 52 to the same input terminal of IC 85 as a second or alternate drawer open input signal. Switch 76, when closed, provides the CTS signal from pin 8 of connector 52 as yet another drawer open input signal to the same terminal of IC 85.

Switch 77, when closed, provides a drawer status output signal from IC 85 to pin 8 of connector 52 as the CTS signal. Switch 78, when closed and if jumper 83 is in the position indicated in FIG. 13A, also provides the drawer status output signal from IC 85 to pin 9 of connector 52 as the RI signal. If switch 79 is closed, the drawer output status signal is alternately provided to terminal pin 6 of connector 52 as the DSR signal. If switch 80 is closed, the drawer status output is alternately provided at the TXD pin 3 of connector 52.

IC 85 also receives a DRW_STAT signal on line 90. IC 85 provides output signals RXD on line 91 and RTS on line 92.

Connector 53 provides input power for the circuitry 70 on a line 87 to a voltage regulator IC 88, which may provide a regulated output voltage of about 5 volts at terminal 89. Transient suppressors 86 provide circuitry protection against over-voltage transients.

Connector 44, which is the same connector shown in FIGS. 5, 9 and 11 provides a DRW_SWITCH or drawer open signal on line 93. Transistor 94 receives a DRV_SOL signal on a line 95 to drive solenoid 31 of the latching mechanism 26 (FIG. 12) via connector 44 to open drawer 24 when the DRV_SOL signal renders transistor 94 conductive.

A second switch SW2, generally designated by reference numeral 100, includes eight switches 101-108 that correspond to the eight positions for switch SW2 indicated in FIG. 15. Note that these positions of switch SW2 are only effective if another switch SW3, generally designated 110 has its first switch 111 in the smart mode. Switches 101-107 provide inputs to an 8-bit microcontroller 125 for ASCII character bit selection. Thus, circuitry 70 can be configured to select one of any of several ASCII characters to open the drawer 24. This enables separate control of opening a select one of several different drawers 24. For example, several cash drawers 20 may be daisy chained together to the same serial port of the computer 16 and still be able to individually report on the open or closed status of each drawer 24, 24a, etc. Microcontroller 125 is commercially available, for example, from Microchip Technology, Inc. of Chandler, Ariz. under part number PIC16F627.

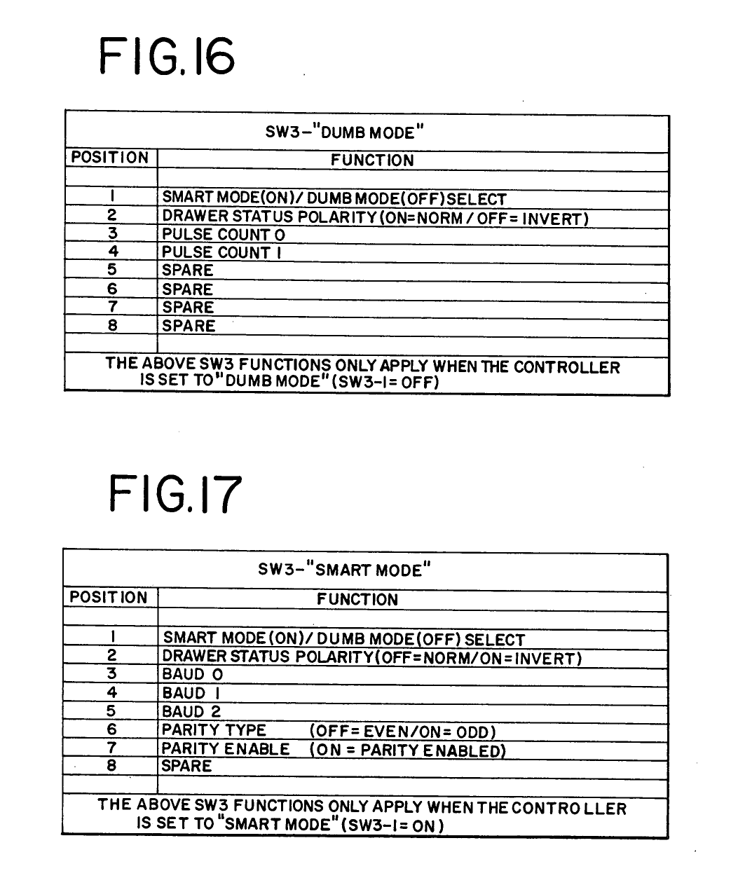

Switch 108 controls the number of data bits, as indicated in FIG. 15, by applying an input signal when closed to an input terminal of an eight-bit parallel input/serial output shift register IC. Its serial output, SR_DATA, is provided on output line 121. As can be seen in FIG. 17, when switch 111 is in the smart mode, switch 112 is selected to have the drawer status polarity inverted and switches 113, 114 and 115 select the baud rate, as shown for the different positions of switches 113-115 in FIG. 18. A switch 116 selects the parity type and a switch 117 selects parity enable.

When switch 111 places the operation of circuitry 70 in the dumb mode, as can be seen in FIG. 16, switch 112 is selected to provide normal drawer status polarity and switches 113 and 114 control the pulse count selection as indicated in FIG. 19. When in the “dumb mode”, drawer 24 may be opened with any random open character. There is no need to select a specific open character, as in the “smart mode”.

Microcontroller 125 has its clock rate defined by a crystal 122, for example, at about 4.91 MHz. One of the LEDs 84 in the LED panel 54 is activated by microcontroller 125 to indicate that the circuitry 70 has power and/or that it has activity. Microcontroller 125 may also activate an LED 132 to indicate RTS status and an LED 133 to indicate drawer status. LEDs 132 and 133 are also in the LED panel 54 in FIG. 8. An IC 124 is an assists in the programming of microcontroller 125. It is also commercially available from Microchip Technology under the designation ICD 2. A plurality of test points 123 is used for testing purposes.

Microcontroller 125 receives input signals RXD on a line 128, DRW_SWITCH on a line 129, RTS on a line 130 and SR_DATA on a line 131. It provides output signals DRV_SOL on line a 126 and DRW_STAT on a line 127.

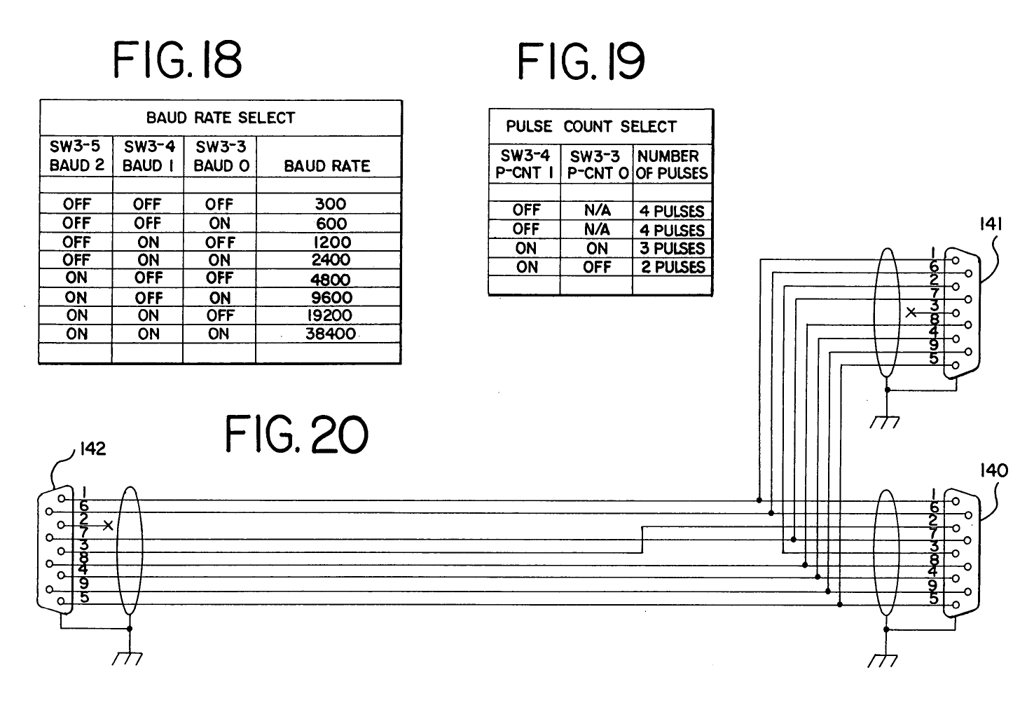

FIG. 20 illustrates a wiring diagram for connecting two cash drawers 20 and 20a to a single serial port of computer 16 while maintaining independent detection of the open drawer status of either drawer. A nine-pin connector 140 is suited to mate with connector 52 of a first serial interface module 50 on a first cash drawer 20, a second nine-pin connector 141 is suited to mate with a second serial interface module 50 on a second cash drawer 24a and a third nine-pin connector 142 is suited to connect to a port on computer 16. Of course, the cable shown in FIG. 20 could be expanded, as previously discussed, to enable daisy chaining of several cash drawers while also maintaining the ability to independently monitor the open status of any drawer 24, 24a, etc. Thus, several cash drawers can be connected to a single COM port of computer 16. A command can be sent to open any one of the several cash drawers. Each of several cash drawers can also independently report back to computer 16 if they are open or closed via different signals of the RS232 line.

While particular embodiments of the invention have been shown and described, it will be obvious to those skilled in the art that changes and modifications may be made therein without departing from the invention in its broader aspects.

1. A cash drawer for a point of sale system, said cash drawer comprising:
a housing;
a drawer slidably mounted in the housing such that the drawer is movable between an open position and a closed position; and
a first interface module mounted on said housing, said first interface module having an electrical connector for communicating information about the status of the cash drawer with the point of sale system in accordance with a first type of communication protocol, and
said first interface module is replaceable with a second interface module having a second type of communication protocol.

2. The cash drawer in accordance with claim 1, said first interface module is selected from a printer driven interface module, a standard serial interface module, a multi-serial interface module or a USB interface module.

3. The cash drawer in accordance with claim 1, said second interface module is selected from a printer driven interface module, a standard serial interface module, a multi-serial interface module or a USB interface module.

4. The cash drawer in accordance with claim 1, said cash drawer further comprising:
a sensor to sense the open position or the closed position of said drawer, said sensor in electrical communication with the first interface module to communicate the position of the drawer to said connector.

5. The cash drawer in accordance with claim 4, said cash drawer further comprising:
electronic circuitry in communication with said connector, said electronic circuitry communicating a unique identity associated with said cash drawer to the connector.

6. A plurality of cash drawers for a point of sale system, each of said plurality of cash drawers comprising:
a housing;
a drawer slidably mounted in the housing such that the drawer is movable between an open position and a closed position;
a first interface module mounted on said housing, said first interface module having an electrical connector for communicating information about the status of the cash drawer with the point of sale system in accordance with a first type of communication protocol;
a sensor to sense the open position or the closed position of said drawer, said sensor in electrical communication with the first interface module to communicate the position of the drawer to said connector; and
electronic circuitry in communication with said connector, said electronic circuitry communicating a unique identity associated with each of said plurality of cash drawers to the connector, such that any open drawer in the plurality of cash drawers can be uniquely identified.

7. The plurality of cash drawers in accordance with claim 6, wherein said first interface module in each of said plurality of cash drawers is replaceable with a second interface module having a second type of communication protocol.

8. The plurality of cash drawers in accordance with claim 7, said first interface module is selected from a printer driven interface module, a standard serial interface module, a multi-serial interface module or a USB interface module.

9. The plurality of cash drawers in accordance with claim 7, said second interface module is selected from a printer driven interface module, a standard serial interface module, a multi-serial interface module or a USB interface module.

10. A method of providing an interchangeable communication protocol for a cash drawer for a point of sale system, said method comprising the steps of:
providing a housing for the cash drawer;
mounting a drawer in the housing such that the drawer is movable between an open position and a closed position;
mounting an interface module on said housing; and
providing an electrical connector on the interface module for communicating information about the status of the cash drawer with the point of sale system in accordance with a type of communication protocol.

11. The method of providing an interchangeable communication protocol for a cash drawer in accordance with claim 10, said method further comprising the step of:
replacing said interface module with another interface module having another type of communication protocol.

12. The method of providing an interchangeable communication protocol for a cash drawer in accordance with claim 10, said method further comprising the step of:
selecting the interface module from a printer driven interface module, a standard serial interface module, a multi-serial interface module or a USB interface module.

13. The method of providing an interchangeable communication protocol to a cash drawer in accordance with claim 11, said method further comprising the step of:
selecting said another interface module from a printer driven interface module, a standard serial interface module, a multi-serial interface module or a USB interface module.

14. The method of providing an interchangeable communication protocol for a cash drawer in accordance with claim 10, said method further comprising the steps of:
sensing the open position or the closed position of said drawer, and
communicating the position of the drawer to said connector of the interface module.

15. The method of providing an interchangeable communication protocol for a cash drawer in accordance with claim 10, said method further comprising the step of:
communicating a unique identity associated with said cash drawer to the connector of the interface module.

16. A method of sensing and identifying an open drawer in a plurality of cash drawers for a point of sale system, said method comprising the steps of:
providing a housing for each of the plurality of cash drawers;
mounting a drawer in each housing such that the drawer is movable between an open position and a closed position;
mounting an interface module on each housing;
providing an electrical connector on each interface module for communicating information about the status of each cash drawer with the point of sale system in accordance with a type of communication protocol;
sensing the open position or the closed position of each drawer;
communicating the position of each drawer to the respective connector; and
communicating a unique identity associated with each of said plurality of cash drawers to the respective connectors, such that any open drawer in the plurality of cash drawers can be uniquely identified.

17. The method of sensing and identifying an open drawer in a plurality of cash drawers in accordance with claim 16, said method comprising the further step of:
replacing said interface module with another interface module having another type of communication protocol.

18. The method of sensing and identifying an open drawer in a plurality of cash drawers in accordance with claim 16, said method comprising the further step of:
selecting said interface module from a printer driven interface module, a standard serial interface module, a multi-serial interface module or a USB interface module.

19. The method of sensing and identifying an open drawer in a plurality of cash drawers in accordance with claim 17, said method comprising the further step of:
selecting said another interface module from a printer driven interface module, a standard serial interface module, a multi-serial interface module or a USB interface module.
